(19) United States
(12) Patent Application Publication
(10) Pub. No.: US 2020/0355472 A1
(43) Pub. Date: Nov. 12, 2020

(54) Aluminum Encapsulation of Ceramic Spheres for Armor Applications

(71) Applicant: The United States of America, as represented by the Secretary of the Navy, Arlington, VA (US)

(72) Inventors: Raymond Mark Gamache, Salinas, CA (US); Jarrod M. Robinson, Monterey, CA (US)

(21) Appl. No.: 16/870,831

(22) Filed: May 8, 2020

Related U.S. Application Data
(60) Provisional application No. 62/845,125, filed on May 8, 2019.

(51) Int. Cl. F41H 5/04; C04B 35/63; C04B 41/51; C04B 35/10

(52) U.S. Cl. CPC F41H 5/0421; C04B 35/6303; C04B 2235/528; C04B 35/10; C04B 2237/121; C04B 41/5155

(57) ABSTRACT

Body armor composite material that includes a substrate, a tempered aluminum binder, and ceramic spheres embedded in the binder. The ceramic spheres have interstitial space that are filled by the aluminum binder.

### CROSS REFERENCE TO RELATED APPLICATION

Pursuant to 35 U.S.C. § 119, the benefit of priority from provisional application 62/845,125, with a filing date of May 8, 2019, is claimed for this non-provisional application.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to plate armor for use in armor vehicles and personal armor. In particular, the invention relates to encapsulated ceramic armor that defeats projectile by breaking incident projectiles into pieces.

Military personnel have required protection from enemy weapons for at least four millennia. The advent of kinetic projectiles propelled by chemically produced gas discharge, such as from firearms in the past few centuries, substantially increased kinetic energy transfer to the target's body, thereby raising the risk of mortal injury. Conventional monolithic ceramic front facing armor is not durable and is susceptible to cracking when mishandled or stored improperly. Further; typical monolithic ceramic front facing armor will crack once impacted by a projectile, thereby decreasing its performance and stopping power.

### SUMMARY

Conventional ceramic armor yield disadvantages addressed by various exemplary embodiments of the present invention. In particular; various exemplary embodiments provide body armor composite material that includes a substrate, a tempered aluminum binder; and ceramic spheres embedded in the binder. The ceramic spheres have interstitial space that are filled by the aluminum binder.

In various embodiments, the ceramic spheres are composed of various combinations of aluminum oxide, silicon carbide, boron carbide, boron nitride, silicon nitride, and zirconium oxide. The solids can be spheres arranged in a single-layer pattern substantially parallel to the substrate arranged in a close packed structure where each adjoining row is offset by ½ a sphere diameter.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 shows an example arrangement of ceramic spheres in accordance with embodiments of the invention;

FIGS. 2A and 2B show an example crucible and example piston, respectively, for manufacturing in accordance with embodiments of the invention;

FIGS. 3A-3B show an example manufacturing process in accordance with embodiments of the invention; and

FIG. 4 shows an example body armor composite material in accordance with embodiments of the invention.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Conventional body armor teaches, for example, molded ceramic tiles disposed in armor pockets contoured to the body geometry where the tile can be disposed. Each tile forms a small-arms protective insert (SAPI) ballistic plate to protect the wearer from small caliber projectile weapons. Three problems occur with this conventional configuration: limited flexibility, tile interface vulnerabilities and lack of multi-hit capability. As a large fixed tile, the SAPI plate restricts movement of the soldier, and after an impact the plate may experience large damage areas leaving vulnerabilities when a second impact occurs in a nearby area. Typically there are four tiles placed at locations both front and back as well as left and right sides. This leaves unprotected areas in the gaps between the plates. Further, monolithic ceramic front facing armor is susceptible to cracking when mishandled or stored improperly.

In a ceramic ball armor composite, a continuous mesh of the ceramic balls avoids such gap vulnerabilities by being disposed throughout the protected areas by absorption and deflection of kinetic energy from the striking projectile. Recent tests have demonstrated that performance characteristic even when impacts are performed within “gaps” between balls, minimizing the performance difference between striking in the gaps and direct impact to the sphere. Exemplary embodiments of personnel armor can be designed to specified performance levels at https://www.ncjrs.gov/pdffiles1/nij/223054.pdf by the National Institute of Justice (NIJ). Through varying both ceramic ball diameter and spall liner thickness, various levels can be achieved, with higher NIJ levels requiring more material than lower levels.

The invention uses aluminum to encapsulate ceramic spheres that enables both the ability to arrest an incident projectile (when combined with a textile armor backing system) as well as prevent current issues when using monolithic plates. The encapsulated ceramic composite material addresses issues include poor multi-hit capability and fracture damage. Specifically, the encapsulated ceramic spheres within a high tensile strength aluminum will resist the fracture damage and reduce ballistic impact damage to surrounding spheres only.

Conventional body armor protection incorporates silicon carbide (SiC) and boron carbide (B₄C) ceramic SAPI plates backed by a spall liner of Kevlar® or ultra-high molecular weight polyethylene (UHMWPE). Example conventional body armor configurations include the Outer Tactical Vest (OTV) used by the U.S. Army, and the Modular Tactical Vest (MTV) used by the U.S. Marine Corps. These use an embedded spall liner and large pockets in which to insert SAPI plates in the front, back and sides of the MTV to protect key organs. Such a design is comparatively bulky and heavy, so as to limit flexibility and contribute to fatigue of the wearer. Additionally, exemplary SAPI plates cost between $350 and $600 each, so the vests can be expensive. Further; the conventional SAPI plates lack multi-impact protection.

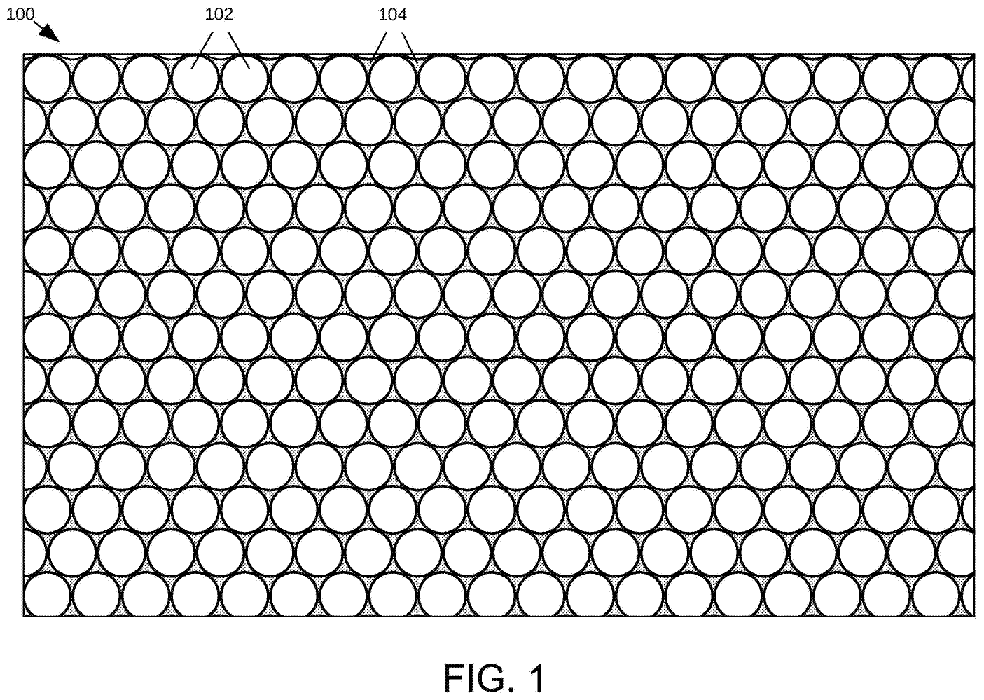

FIG. 1 shows an example arrangement 100 of ceramic spheres 102. The ceramic spheres 102 are arranged in a hexagonal close packed geometric arrangement 100, where each ceramic sphere 102 has six neighboring ceramic spheres 102 that share a common plane. In other words, the ceramic spheres 102 are arranged so that each layer of ceramic spheres 102 is shifted by half the sphere diameter. Interstitial voids 104 exist between the ceramic spheres. The ceramic sphere 102 size can vary from between, for example, a quarter inch to an inch.

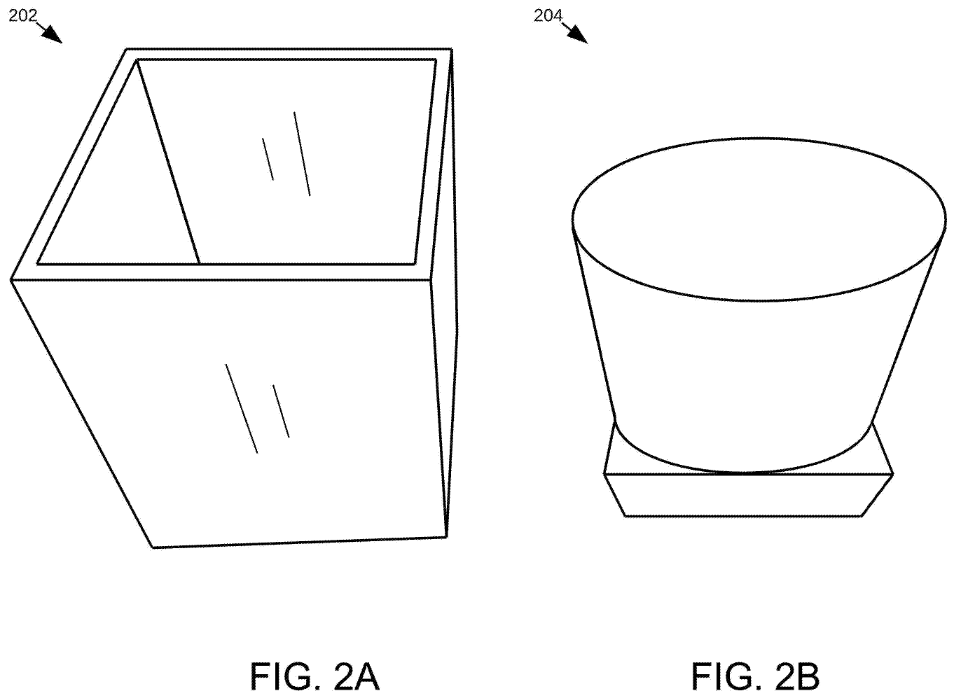

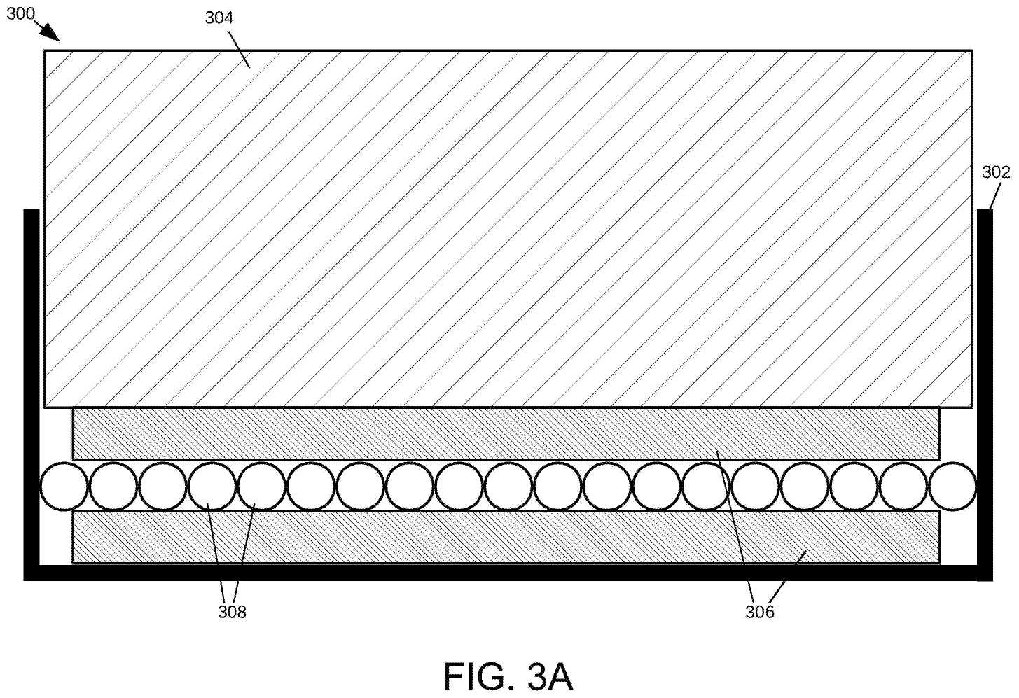

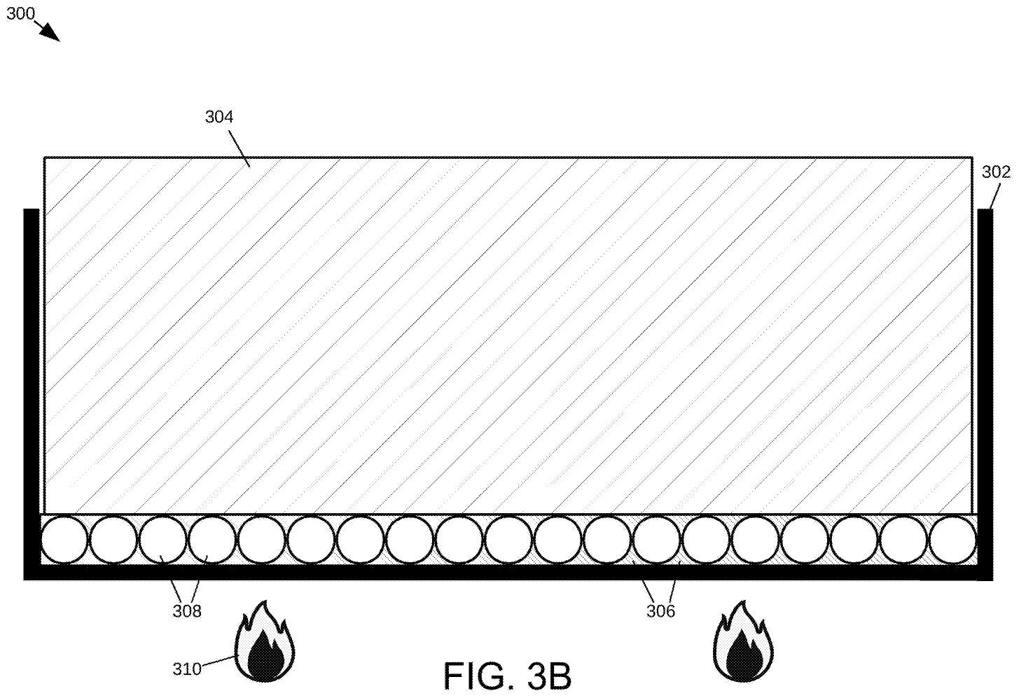

FIGS. 2A and 2B shows an example crucible 202 and an example piston 204 for manufacturing encapsulated ceramic armor material. The components for manufacturing are placed in the bottom of the crucible 202 for baking in a furnace as described below with respect to FIGS. 3A-3B. The example piston 204 may then be placed on top of the components so that when the components are baked, the armor material is manufactured.

FIGS. 3A-3B show an example manufacturing process in accordance with embodiments of the invention. As is the case with the other processes described herein, various embodiments may not include all of the steps described below, may include additional steps, and may sequence the steps differently. Accordingly, the specific arrangement of steps shown in FIGS. 3A-3B should not be construed as limiting the scope of the invention.

In FIG. 3A, an initial configuration 300 for manufacturing is shown that is includes a crucible 302, a piston 304, aluminum elements 306, and ceramic spheres 308. Aluminum elements 306 are placed below and above the ceramic spheres 308 in the crucible 302. The ceramic spheres 308 can be arranged in a variety of configurations (e.g., the hexagonal closed packed configuration shown in FIG. 1). Parameters (e.g., ceramic sphere size, composition of ceramic spheres, etc.) of the initial configuration 300 can be selected based on the planned use of the armor product. After the components of the initial configuration 300 are arranged, the configuration 300 can be placed in an oven (not shown) for baking.

In FIG. 3B, the initial configuration 300 of FIG. 3A is shown inside a furnace while heat 310 is being applied. When the aluminum element 306 melts, the aluminum element 306 fills interstitial voids of the ceramic elements 308. After the interstitial voids are filled, encapsulated ceramic armor material is produced. Further processing may be performed on the encapsulated armor material to create an armor plate. For example, the aluminum can be tempered. Further, the encapsulated armor material can be affixed to an armor substrate (not shown).

Those skilled in the art will appreciate that other techniques can be used to manufacture armor material as described herein. For example, the melted aluminum can be injected into the interstitial voids of the ceramic spheres.

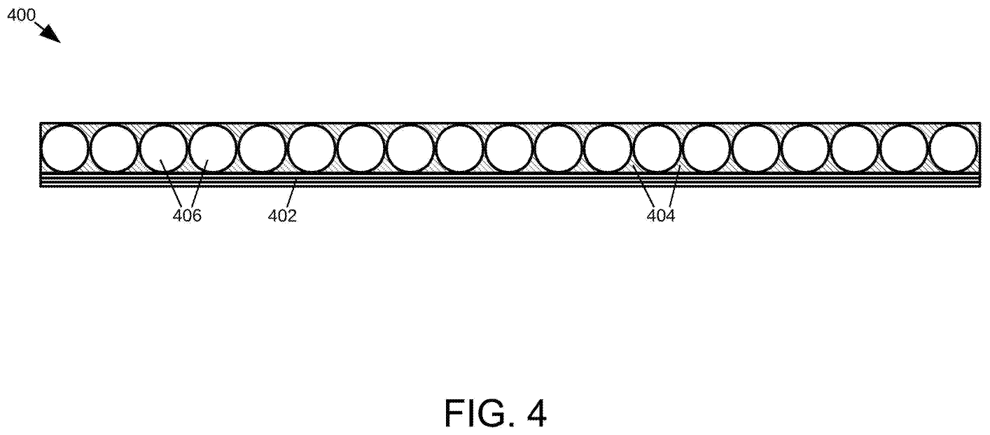

FIG. 4 shows an example armor portion 400 in a cross-section view. The cross-section 400 of the armor portion 400 includes an armor substrate 402, tempered aluminum 404, and ceramic spheres 406. The ceramic spheres 406 can be produced from various metal carbide, nitride or oxide compounds. A cover fabric for camouflage or decorative purpose can be overlaid to obscure the armor portion 400 from visual observation.

Various exemplary embodiments provide the ceramic spheres 406 too include diameters ¼″ (0.25 inch) up to 1 inch and form an encapsulated layer having thicknesses that substantially correspond to the diameters of the spheres 406. The ceramic components form a spherical shape, although alternate substantially symmetrical solids, such as the octahedron, dodecahedron and icosahadron can be used without departing from the scope of the invention. Complete encapsulation with overall layer thickness between ¼″ and 1 inch.

Candidate ceramic materials include aluminum oxide (alumina or Al₂O₃) of all chemical purity varieties, silicon carbide (SiC), and boron carbide (B₄C), the latter two being both sintered and hot pressed. Alternate materials include boron nitride (BN), silicon nitride (Si₃N₄), and zirconium oxide (zirconia or ZrO₂). Preferably, the ceramic spheres 406 are at least 90% alumina. Regardless of the ceramic material selected, a high hardness and compression strength is preferable. A Vickers Hardness number of at least 15 is suitable, and a Vickers Hardness number of at least 30 is preferable. The pattern such as the one shown in FIG. 1 exhibits a high degree of symmetry. The ceramic spheres 406 are uniform and oriented in the direction of anticipated impact.

Returning to FIG. 1, the configuration and arrangement of the composite ceramic body armor system can be characterized as encapsulated ball matrix serving as the “strike face” along the front surface. The ceramic spheres 102 arranged in a patterned layer within the melted aluminum constitute the encapsulated ball matrix. A flexible adhesion is provided between that encapsulated ball matrix and an armor substrate. Additionally the entire body armor system may be wrapped in a fabric material to provide: protection of armor system, uniformity with existing clothing and camouflage options. Performance gains from this feature include: increased flexibility, multi-hit capability, lower cost and lighter weight (as compared to conventional armor for equal performance characteristics).

Damage areas after an impact tend to be minimal where typically only two or three ceramic spheres 102 are removed. The application of the ceramic ball body armor can be integrated to primarily protect the torso and groin area due not only to damage vulnerability but also to target size compared to the head and appendages, such as arms and legs.

The exemplary garment form can be described primarily of a vest, but could include an outer garment protecting the groin area. Customized designs can be incorporated based on threat requirements. Increased threats would need to include larger ceramic balls and thicker spall liners. The protection system would be worn similar to the conventional existing SAPI system as an over garment in tactical conditions. In 2008, the United States Army stated that the SAPI plate system was not a final state for body armor protection. Future requirements would include increased flexibility and lighter weight. The ceramic ball armor disclosed in exemplary embodiments addresses both issues.

Production of the composite body armor include spraying polymer binder onto the substrate, such as with Gusmer® spray equipment from Gusmer-Decker (acquired by Graco) of North Canton, Ohio, and potting the spheres 102 into the sprayed polymer prior to its curing. The polymer surrounding the ceramic balls must enable flexible motion of the encapsulated ceramic ball matrix. Other techniques for producing such body armor can be envisioned by artisans of ordinary skill without departing from the scope of the invention.

In exemplary embodiments, the encapsulated ceramic ball serves as the “strike face” of the body armor system. Flexible adhesion is provided between the encapsulated ball system and the spall liner. Additionally, the entire body armor system may be wrapped in a fabric material to provide: protection of armor system, uniformity with existing clothing and camouflage options. Benefits from this design include: increased flexibility, multi-hit capability, lower cost and lighter weight (as compared to conventional armor for comparable performance characteristics).

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A body armor composite material, said material comprising:
an armor substrate;
an aluminum binder disposed on the armor substrate; and
a plurality of ceramic spheres embedded within the aluminum binder, the plurality of ceramic spheres having interstitial spaces that are filled by the aluminum binder.

2. The body armor composite material of claim 1, wherein each of the plurality of ceramic spheres is between approximately ¼″ and 1″ in diameter.

3. The body armor composite material of claim 1, wherein the plurality of ceramic spheres are composed of at least one of aluminum oxide (Al₂O₃), silicon carbide (SiC), boron carbide (B₄C), boron nitride (BN), silicon nitride (Si₃N₄), and zirconium oxide (ZrO₂).

4. The body armor composite material of claim 1, wherein the plurality of ceramic spheres are arranged in a hexagonal close packed geometric arrangement in which each ceramic sphere has six neighboring ceramic spheres that share a common plane.

5. The body armor composite material of claim 1, wherein the aluminum binder is tempered.

6. A process for fabricating body armor composite material, the process comprising:
arranging a plurality of ceramic spheres in a hexagonal close packed geometric arrangement in which each ceramic sphere has six neighboring ceramic spheres that share a common plane;
adding aluminum binder to interstitial spaces of the plurality of ceramic spheres to create an encapsulated ceramic sphere armor plate.

7. The process of claim 6, further comprising attaching an armor substrate to the encapsulated ceramic sphere armor material.

8. The process of claim 6, wherein adding aluminum binder is by:
positioning aluminum elements above and below the plurality of ceramic spheres in a furnace; and
melting the aluminum elements so that the aluminum elements fill the interstitial spaces.

9. The process of claim 6, wherein adding aluminum binder is by injecting aluminum into the interstitial spaces.

10. The process of claim 6, further comprising tempering the aluminum binder.
